(19) United States
(12) Patent Application Publication
(10) Pub. No.: US 2007/0088853 A1
(43) Pub. Date: Apr. 19, 2007

(54) Communication method between IPv6 mobile node and IPv4-based node using DSTM in MIPv6 environment

(75) Inventors: Sang Do Lee, Gyeonggi-do (KR); Myung Ki Shin, Daejeon-city (KR); Hyoung Jun Kim, Daejeon-city (KR); Hyeong Ho Lee, Daejeon-city (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/471,825

(22) Filed: Jun. 20, 2006

(30) Foreign Application Priority Data
Oct. 13, 2005 (KR) 10-2005-0096516

(51) Int. Cl. G06F 15/16

(52) U.S. Cl. 709/249

(57) ABSTRACT

Provided is a communication method between an IPv6 mobile node and an IPv4-based correspondent node in a mobile IPv6 (MIPv6) environment, and more particularly, a communication method which can keep communication between a mobile node in an IPv6-based network and a correspondent node in an IPv4-based network, although the mobile node, which communicates with the node in the IPv4-based network, moves to a foreign network. In order to support mobility between the both networks, a DSTM gateway (or DSTM TEP) corresponding to a DSTM border router processes a binding update request received from an IPv6 mobile node.

### CROSS-REFERENCE TO RELATED PATENT APPLICATION

This application claims the benefit of Korean Patent Application No. 10-2005-0096516, filed on Oct. 13, 2005, in the Korean Intellectual Property Office, the disclosure of which is incorporated herein in its entirety by reference.

### BACKGROUND OF THE INVENTION

1. Field of the Invention

The present invention relates to a communication method between an IPv6 mobile node and an IPv4-based node in a mobile IPv6 (MIPv6) environment, and more particularly, to a communication method which can keep communication between a mobile node in an IPv6-based network and a node in an IPv4-based network, although the mobile node, which communicates with the node in the IPv4-based network, moves to a foreign network.

2. Description of the Related Art

A dual stack transition mechanism (DSTM) is an IPv4-to-IPv6 transition proposal based on the use of IPv4 over IPv6 dynamic tunnels and the temporary allocation of IPv4 global address to dual-stack hosts.

The DSTM enables an IPv6-based network to communicate with an IPv4-based network by IPv4-in-IPv6 tunneling, and assures communication between the both networks without correcting the existing IPv4 application. The DSTM is used when the IPv6-based network which is a next-generation Internet network is established and communicates with the existing IPv4-based network.

The DSTM is being standardized in the Internet engineering task force (IETF) and currently applied only in a general network environment. Furthermore, standardization of a MIPv6 which is an IPv6-based mobile framework for supporting mobility of all the terminals and nodes in the IPv6-based network is completed.

The MIPv6 enables a mobile terminal (or mobile node) to keep communication with other mode even when the mobile terminal, which performs IP communication in the IPv6-based network, moves from a home network to a foreign network. Accordingly, when the mobile node (MN) moves to another domain, the mobile node (MN) generates a care-of address (CoA) which can be used in the domain and transmits/receives information on the care-of address (CoA) to/from a correspondent node (CN) in order to perform the communication using the care-of address (CoA). In addition, in order to keep the communication, address information of the mobile node includes its original home address (HoA) and the care-of address (CoA).

However, research into the MIPv6 which is ongoing up to now is on the assumption that all the terminals are IPv6 nodes, that is, all the terminals are positioned in the IPv6-based network environment. The research into the support of the mobility in the communication between IPv4-based network and the IPv6-based network is not ongoing.

In the present circumferences, when a MIPv6 platform is used in an IPv6/IPv4 network, since a binding update function necessary for supporting the mobility is not performed, a route optimization function which is a basic function of the IPv6 cannot be performed and thus the mobility between the both networks can be supported only using a triangular routing method.

### SUMMARY OF THE INVENTION

The present invention provides a system and method which can support direct communication between a mobile node in an IPv6-based network and a node in an IPv4-based network using a DSTM, and more particular, a system and method which can support (assure) mobility.

According to an aspect of the present invention, there is provided a communication method between an IPv6 mobile node and an IPv4-based node in a MIPv6 environment using a Dual Stack Transition Mechanism (DSTM), including: (a) when the mobile node, which is communicating with the IPv4-based node, moves to foreign network, transmitting message for binding update to Dual Stack Transition Mechanism Tunnel End Point (DSTM TEP); (b) allowing the DSTM TEP to designate care of address (CoA), which is used by the mobile node in the foreign network, in its address mapping table referring to an IPv6 home address (HoA) designated in header of the message; and (c) when an IPv4 packet is received from the IPv4-based node, allowing the DSTM TEP to encapsulate the IPv4 packet to IPv4-in-IPv6 packet referring to the care of address (CoA) as a destination address and to directly transmit the IPv4-in-IPv6 packet to the mobile node in the foreign network, such that direct communication between the both nodes can be performed while assuring mobility although the mobile node moves to the foreign network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a configuration of a basic network for embodying a DSTM;

FIG. 2A illustrates a configuration of a network using the DSTM when a mobile node is positioned in a home network;

FIG. 2B illustrates a configuration of a network using the DSTM when a mobile node is positioned in a foreign network;

FIG. 3 is a flowchart illustrating a procedure for processing a message generated when an IPv6 mobile node, which communicates with a correspondent node in an IPv4-based network, moves from a home network to a foreign network using the DSTM, according to an embodiment of the present invention;

FIG. 4 illustrates an example of a message format when a mobile node is positioned in a home node and a packet is transmitted to a DSTM tunnel end point (TEP);

FIG. 5 illustrates an example of a packet which is transmitted from a home agent to a mobile node when the mobile node is positioned in a foreign node; and

FIG. 6 illustrates an example of a binding update message format according to the present invention when a mobile node is positioned in a foreign network.

### DETAILED DESCRIPTION OF THE INVENTION

In order to facilitate understanding of a configuration and operation of the present invention, the technical spirit and terminology of the present invention will be first described.

The aim of the present invention is to support direct communication between an IPv6-based mobile node and an IPv4-based node and to enable a dual stack transition mechanism (DSTM) gateway (or DSTM tunnel end point (TEP)) corresponding to a DSTM border router to process a binding update request received from an IPv6 mobile node. Accordingly, three functions defined in a MIPv6 protocol, that is, 1) a return routerability (RR) function, 2) a binding update message process function, and 3) an IPv6 expansion header (routing header and destination option header) process function are added to the DSTM TEP.

Furthermore, in order to solve a triangular routing problem, a home address (HoA) and a care-of address (CoA) of a mobile node are specified using an address designating method of an address mapping table in the DSTM TEP, which is different from the existing method.

The terminology used in the present invention is as follows:

Mobile IPv6 (MIPv6): A mechanism suggested by a mobile IPv6 working group for supporting mobility in an IPv6-based network.

IPv6 mobile node (IPv6 MN): A node which changes its network connection position in the IPv6-based network. In the present invention, the IPv6 mobile node includes a DSTM client function (IPv4-in-IPv6 tunneling function).

IPv4 correspondent node (IPv4 CN): In general, a correspondent node (CN) indicates a correspondent node in the IPv6-based network. In the present invention, the IPv4 correspondent node indicates a correspondent node in an IPv4-based network which communicates with the mobile node.

Home agent (HA): A router which has a home address (HoA) and a care-of address (CoA) of a mobile node in a home network and sends a datagram to the current position of the mobile node when the mobile node moves from the home network and a foreign network.

Home address (HoA): IPv6 address which is used by a mobile node in the home network.

Care-of address (CoA): An address which is generated by RFC1462 or RFC3315, which is an address generating method of the IPv6, and is assigned to the mobile node when the mobile node moves to the foreign network. The mobile node uses the care-of address as an IPv6 address in the foreign network.

Address mapping table: A table for recording an IPv6 source address and an IPv4 source address of a packet which is input to the DSTM TEP.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art. Like reference numerals in the drawings denote like elements, and thus their description will be omitted.

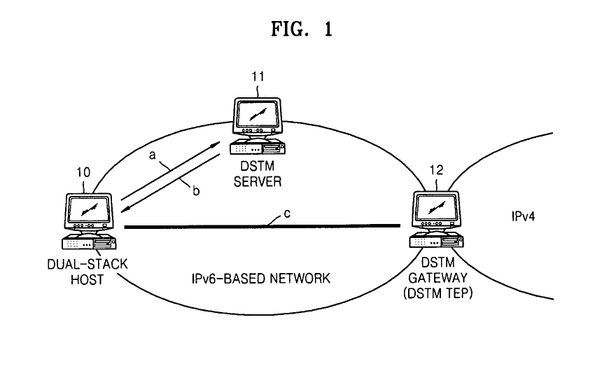

FIG. 1 illustrates a configuration of a basic network for embodying a DSTM (hereinafter, referred to as “DSTM network”).

Referring to FIG. 1, the DSTM network is embodied by 3 different types of equipments: a dual-stack host 10; a DSTM server who administrates an IPv4 address pool, and a DSTM gateway (or DSTM TEP) 12 in charge of encapsulation and decapsulation of IPv4 over IPv6 packets.

In order to enable the dual-stack host 10 in an IPv6-based network to communicate with a node in the IPv4-based network, the dual-stack host 10 transmits an allocation request message a of a temporal IPv4 address to the DSTM server 11. At that point, the DSTM server 11 reserves one IPv4 address for the host 10 from the address pool and sends the IPv4 address to the dual-stack host 10 on its reply message b. The reply message b also contains the validity time of the allocated address and the information concerning the DSTM gateway 12.

Following the exchange of these messages, the host 10 configures its IPv4 stack c with the allocated address. Using the IPv4 stack c, all the IPv4 packets coming from the host 10 are tunneled to IPv4-in-IPv6 packet and the tunneled IPv4-in-IPv6 packet is transmitted to the DSTM gateway 12.

In order to perform the encapsulation of the IPv4 packets and decapsulation of the IPv4-IPv6 packets, the DSTM gateway 12 has an address mapping table composed of the IPv4 source address and IPv6 source address. In order to assure bidirectional communication, routing in IPv4 network must assure that any packet generated in the host 10 passes through the DSTM gateway 12.

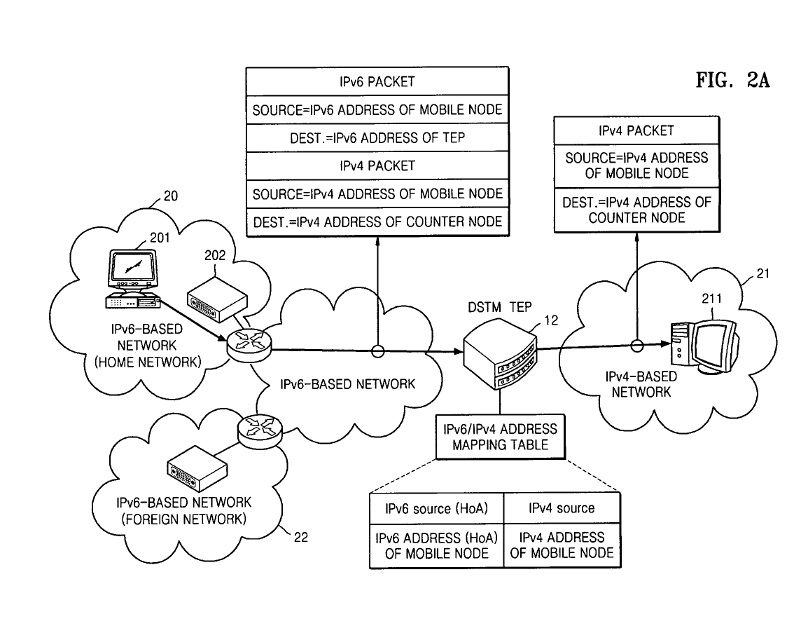

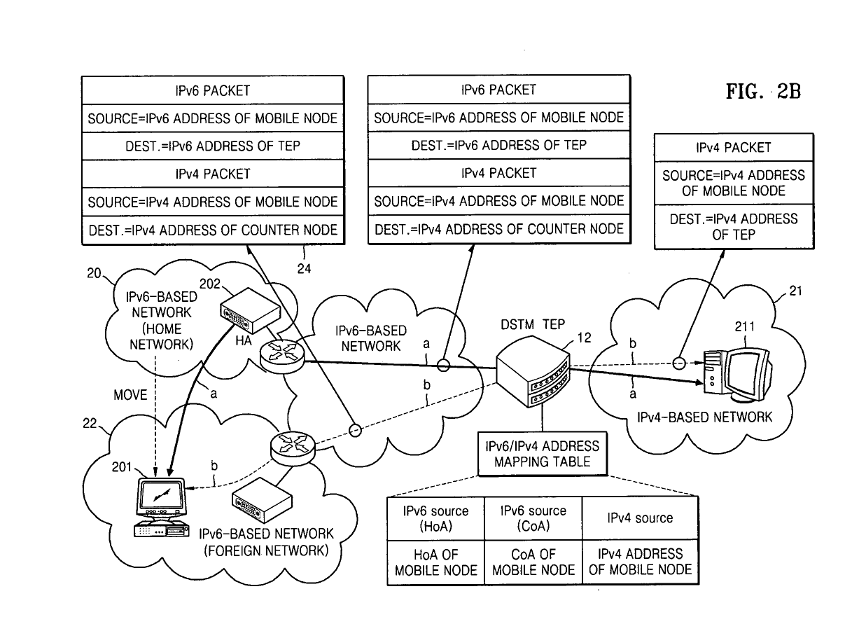

FIGS. 2A and 2B illustrate a configuration of a network using the DSTM in a MIPv6 environment.

Referring to FIG. 2A, when a mobile node 201 in the MIPv6 network environment is positioned in a home network, that is, the mobile node 201 does not move to a foreign network 22, a general DSTM operation, that is, a DSTM operation in an environment to which MIPv6 is not applied, is performed. The DSTM operation is as follows.

Operation 1: The mobile node 201 (MN) having the DSTM client function receives information on a temporal IPv4 address and a tunneling address (TEP address) from the DSTM server 11 in order to communicate with a correspondent node 211 (CN) which is positioned in an IPv4-based network 21.

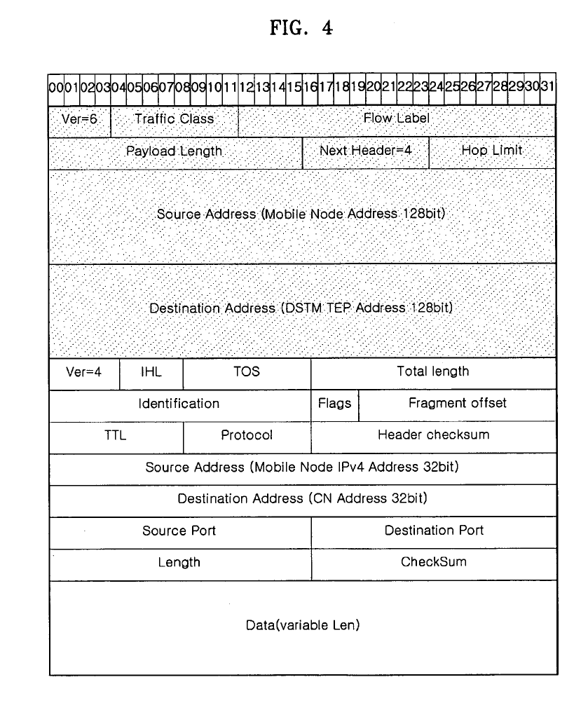

Operation 2: The mobile node 201 transmits an IPv4-in-IPv6 packet to the DSTM TEP 12 using the IPv4-in-IPv6 tunneling method in order to communicate with the correspondent node 211 of the IPv4-based network 21. When transmitting the IPv4-in-IPv6 packet to the DSTM TEP 12, a message is configured with a format illustrated in FIG. 4 and is transmitted.

Operation 3: The DSTM TEP 12 verifies the IPv4-in-IPv6 packet and then designates the IPv6 source address (IPv6 address of the mobile node) and the IPv4 source address (address received from the DSTM server) in an IPv6/IPv4 address mapping table.

Operation 4: The DSTM TEP 12 performs decapsulation (process of removing an IPv6 header) of the IPv4-in-IPv6 packet transmitted from the mobile node 201 positioned in the IPv6-based network 20 (home network) to convert the IPv4-in-IPv6 packet into an IPv4 packet, and transmits the IPv4 packet to the IPv4-based network 21. The decapsulated packet is transmitted to the correspondent node 211, because an IPv4 destination address thereof is that of the correspondent node 211 positioned in the IPv4-based network 21.

Operation 5: On the contrary, the DSTM TEP 12 which receives the IPv4 packet from the IPv4-based network 21 converts the IPv4 packet into a packet tunneled by the IPv4-in-IPv6 encapsulation (addition of IPv6 header) based on its address mapping table information and transmits the tunneled packet to the IPv6-based network 20. In other words, when the mobile node 201 in the home network 20 communicates with the correspondent node 211 in the IPv4-based network, the general DSTM operation is performed.

Referring to FIG. 2B, when the mobile node 201 moves to the foreign network 22 in the MIPv6 environment, the mobile node 201 generates a care-of address (CoA) which will be used in the foreign network 22 using an address generating mechanism which is a basic mechanism of the MIPv6 (for example, stateless or DHCPv6) and requests a home agent 202 (HA) of the home network 20 to perform a binding update function in order to report the care-of address (CoA).

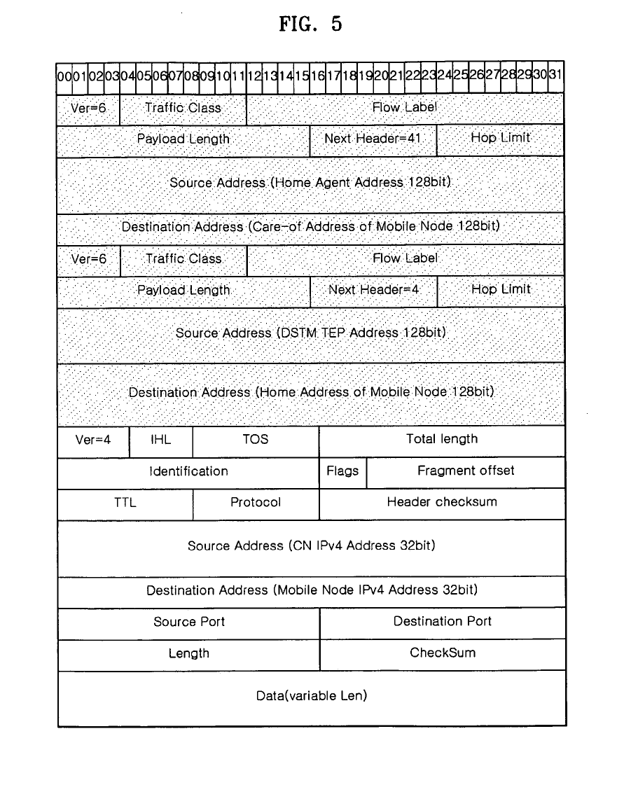

The home agent 202 (HA), which is requested to perform the binding update, designate the care-of address (CoA) corresponding to the home address (HoA) of the mobile node 201 and intercepts the IPv4-in-IPv6 packet received from the DSTM TEP 12, of which the destination address is the home address (HoA). The home agent 202 generates a tunneling packet illustrated in FIG. 5 using the care-of address (CoA) corresponding to the home address (HoA) of the intercepted packet. The generated tunneling packet is transmitted to the foreign network 22 in which the mobile node 202 is positioned.

In order to perform the route optimization, the mobile node 201 which receives the tunneling packet transmits a home address option having home address information to the correspondent node 211. However, the correspondent node 211 is positioned in the IPv4-based network 21 which is in an environment different from that of the mobile node 201, the functions such as the binding update and a return routerability (RR) cannot be performed in the IPv6 environment which does not support mobility by the IPv6.

Accordingly, the mobile node 201 in the IPv6-based foreign network 22 can communicate with the correspondent node 211 in the IPv4-based network 21 only by a triangular routing method using the home agent 202, as indicated by a solid line route a of FIG. 2B. Direct communication cannot be performed while assuring the mobility between the both nodes 201 and 211.

In other words, in order to assure the mobility, only indirect communication using the home agent 202 can be performed, and, in this case, a bottleneck state may occur in the home network 20 and thus fatal problems such as the down of the home agent 202 may appear. Accordingly, a method for solving the problems of the triangular routing method while using the MIPv6 standard is as follows.

As a first method, as mentioned above, a function of the DSTM TEP 21 corresponding to the DSTM border router expands. In other words, in the existing method, since the correspondent node 211 is positioned in the IPv4-based network 21, the binding update and the RR cannot be performed. However, in the present invention, the binding update and the RR are performed in the DSTM TEP 12.

The basic function (basic operation) of the DSTM TEP 12 is based on section 7 of RFC3775 and the following functions (section 9 of RFC 3775) are further embodied in the DSTM TEP 12 in order to embody the present invention.

1) Return Routerablility (RR) Function

This function includes a home test init message (HoTI) process function, a care-of test Init message (CoTI), a home test message (Ho) process function, and a care-of test message (CoT) process function.

2) Binding Update Message Process Function

This function includes a binding update request message process function and a binding acknowledge message process function.

3) IPv6 Expansion Header Process Function

The IPv6 expansion header includes a routing header and a destination option header.

As a second method, address information designated in the address mapping table expands.

In the existing address mapping table, as illustrated in FIG. 2A, only the [IPv6 source (HoA), IPv4 source] field is designated. When a packet is transmitted from the IPv4-based network 21, the DSTM TEP 12 retrieves the IPv4 source field from the table using the IPv4 destination address as a key to obtain the IPv6 source address, which is used in the IPv4-in-IPv6 capsulation. In addition, since the binding update is not performed in the DSTM TEP 12, only the home address of the mobile node is stored as the IPv6 source address. Accordingly, when the IPv6 mobile node 201 moves to the foreign node 22, the direct communication between the both nodes 201 and 211 cannot be performed.

In the present invention, the field expands and the address mapping table includes the IPv6 source (HoA) field, the IPv6 source (CoA) field, and the IPv4 source field, as illustrated in FIG. 2B. When the mobile node 201 requests the DSTM TEP 12 to perform the binding update, the DSTM TEP 12 designates the (CoA) in the IPv6 source (CoA) field using the home address (HoA) contained in the home address option header of the mobile node 201 as a key.

When the IPv4 packet is received from the IPv4-based network 21, if a value is designated in the IPv6 source (CoA) field of the address mapping table, the DSTM TEP 12 decapsulates the IPv4 packet to the IPv6-in-IPv4 packet using this value and directly transmits the IPv6-in-IPv4 packet to the foreign network 22. Accordingly, the IPv4 packet is directly transmitted to the foreign network 22, in which the mobile node 201 exists, as indicated by a dotted line route b of FIG. 2B, without performing the triangular routing method.

When the value of the IPv6 source (CoA) field of the address mapping table does not exist, the mobile node 201 does not move and thus the operation described with reference to FIG. 2A is performed. Accordingly, the binding update is not requested and the packet is encapsulated using the IPv6 source (HoA) field, similar to the existing method.

<DSTM (Mobility Supporting (Assuring) Mechanism) According to the Present Invention>

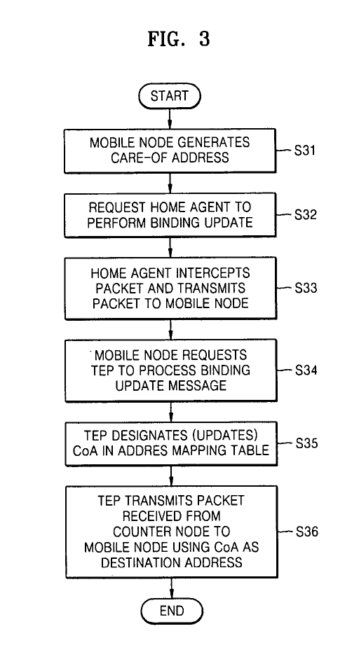

FIG. 3 is a flowchart illustrating a procedure for processing a message generated when the IPv6 mobile node 201, which communicates with the correspondent node 211 in the IPv4-based network 21, moves from the home network 20 to the foreign network 22 using the DSTM, according to an embodiment of the present invention.

When the IPv6 mobile node 201 moves to the foreign node 22, its core-of address (CoA) is generated (S31).

The mobile node 201 notifies the home agent 202 in the home network 20 of the care-of address (CoA) and requests the binding update (S32). The home agent processes the request, intercepts the IPv4-in-IPv6 packet of which the destination address is the home address (HoA) of the mobile node 201, configures a message using the IPv6 encapsulation method with the format illustrated in FIG. 5 in order to perform the tunneling of IPv4-in-IPv6 packet by the care-of address (CoA), and transmits the intercepted packet to the mobile node 201 (S33).

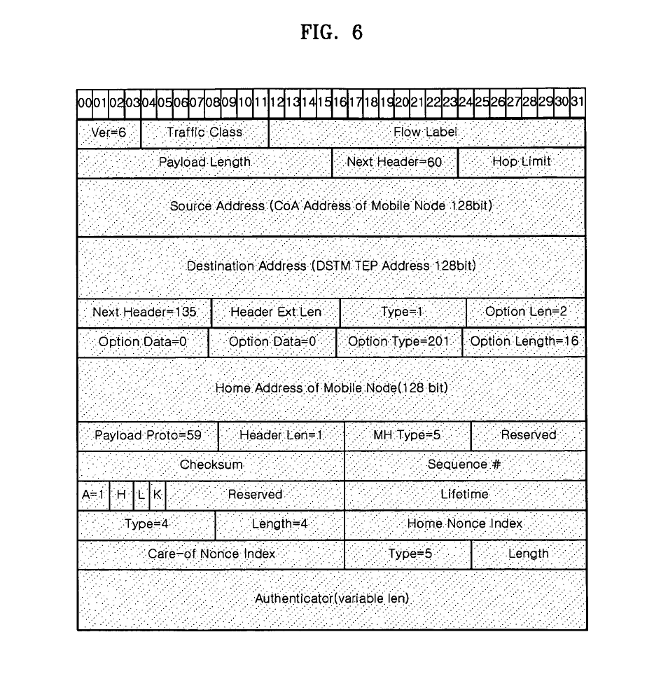

In order to transmit binding update information to the IPv4 correspondent node 211, the IPv6 mobile node 201, which receives the tunneled packet from the home agent 202, transmits a binding update message to the DSTM TEP 12 using the IPv6 destination address (IPv6 address of TEP) (S34). For example, the format of a message for transmitting the binding update packet is illustrated in FIG. 6.

The DSTM TEP 12, which receives the binding update message, retrieves the IPv6 source (HoA) field of its address mapping table using the IPv6 home address (HoA) designated in the binding update message header as a key and updates the value of the IPv6 source (CoA) field, that is, designates the care-of address (CoA) (S35).

When the IPv4 packet is received from the IPv4 correspondent node 211, the DSTM TEP 12 retrieves the IPv4 source field of the address mapping table based on the destination address (IPv6 address of TEP). When the value of the IPv6 source (CoA) field is designated (care-of address (CoA) is designated), the packet is encapsulated to the IPv4-in-IPv6 packet using the care-of address as a destination address and directly transmits the encapsulated packet to the mobile node 201 in the MIPv6 network (foreign network) (S36).

The IPv6 mobile node 201, which receives the encapsulated IPv4-in-IPv6 packet, decapsulates the packet and communicates with the IPv4 node. Accordingly, the communication can be performed without using the home agent, unlike the exiting method.

<Binding Update Function of the IPv6 Mobile Node According to the Present Invention>

The binding update function is very important in supporting the mobility in the MIPv6 environment, as mentioned above.

Referring to FIG. 2B, when the mobile node 201 moves to the foreign network 22 while performing the DSTM client function, the mobile node 201 receives the IPv4-in-IPv6 packet in which the IPv4 header is tunneled from the home agent 202. Since five basic conditions suggested in section 11.7.2 of MIPv6 (RFC 3775) for requesting the correspondent node 211 to perform the binding update function, that is, “1) the received packet is tunneled in the IPv6, 2) the destination address of the tunneled external IPv6 header is identical to the care-of address (CoA) of the mobile node, 3) the destination address of the tunneled internal IPv6 header is identical to the home address of the mobile node, 4) the source addresses of the tunneled external IPv6 header and the tunneled internal IPv6 header are different from each other, and 5) the packet does not contain a home test message, a home test init message, a care-of test message, and a care-of test init message, are satisfied, the IPv6 address of the DSTM TEP 12 is designated in a binding update list table 24 of the mobile node 201 as the address of the correspondent node 211.

The mobile node 201 requests the DSTM TEP 12 to process the binding update message with the address of the correspondent node 211 (here, the address of TEP) in order to perform the route optimization. Accordingly, in the binding update according to the present invention, the DSTM TEP 12 processes the binding update message while using the MIPv6 standard, the mobile node 201 directly communicates with the correspondent node 211 of the IPv4-based network 21.

According to the present invention, in order to perform the communication between the IPv6 mobile node 201 in the MIPv6 network and the correspondent node 211 in the IPv4 network while supporting the mobility, the border router function of the DSTM expands and the DSTM TEP performs the function of the correspondent node in the IPv4 network by proxy. According to the present invention, since the mobility between the existing networks can be automatically provided when introducing a next-generation network, a network can be efficiently configured when introducing the IPv6-based network.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A communication method between an IPv6 mobile node and an IPv4-based correspondent node in a MIPv6 environment using a Dual Stack Transition Mechanism (DSTM), comprising:
(a) when the mobile node, which is communicating with the IPv4-based correspondent node, moves to foreign network, transmitting message for binding update to Dual Stack Transition Mechanism Tunnel End Point (DSTM TEP);
(b) allowing the DSTM TEP to designate care of address (CoA), which is used by the mobile node in the foreign network, in its address mapping table referring to an IPv6 home address (HoA) designated in header of the message; and
(c) when an IPv4 packet is received from the IPv4-based correspondent node, allowing the DSTM TEP to encapsulate the IPv4 packet to IPv4-in-IPv6 packet referring to the care of address (CoA) as a destination address and to directly transmit the IPv4-in-IPv6 packet to the mobile node in the foreign network,
such that direct communication between the both nodes can be performed while assuring mobility although the mobile node moves to the foreign network.

2. The method of claim 1, wherein the binding update is performed by designating an IPv6 address of the DSTM TEP in a binding update list table of the mobile node with the address of the correspondent node and allowing the mobile node to request the DSTM TEP to process the binding update message based on the IPv6 address of the DSTM TEP in order to perform a route optimization function.
